(19) United States
(12) Patent Application Publication
(10) Pub. No.: US 2026/0252693 A1
(43) Pub. Date: Aug. 27, 2026

(54) VEHICLE CYBERSECURITY MONITORING PLATFORM WITH ARTIFICIAL INTELLIGENCE

(71) Applicant: Atieva, Inc., Newark, CA (US)

(72) Inventors: Anuradha Kodali, Newark, CA (US); Srivalli Boddupalli, Newark, CA (US); Haripriya Ambati, Newark, CA (US); Sadath Syed, Newark, CA (US)

(21) Appl. No.: 19/060,300

(22) Filed: Feb. 21, 2025

(51) Int. Cl. G06F 21/56; G06F 21/55

(52) U.S. Cl. CPC G06F 21/566; G06F 21/554; G06F 2221/034

(57) ABSTRACT

A vehicle anomaly detection system is configured to receive data associated with a vehicle, the data comprising one or more logs associated with the vehicle and telemetry data generated by the vehicle. The system may detect a data anomaly associated with the vehicle, including applying at least a machine learning model to the data. In response to detecting the data anomaly to the vehicle, the system may perform a remediation action, and store the data anomaly in memory.

### FIELD

Embodiments disclosed relate generally to automobile technology, and more particularly, to a vehicle cybersecurity monitoring system that includes artificial intelligence.

### BACKGROUND

A vehicle or fleet of vehicles can include a variety of electronic devices that execute programs (e.g., a collection of machine executable instructions such as firmware or software) to operate and/or monitor systems in the vehicle such as, for example, a motor, sensors, batteries, telemetry, throttle, steering, entertainment console, heating, cooling, etc. These electronic devices may be vulnerable cyber security attacks from a threat actor. Given the sheer number of vehicles that may be supported, and the number of devices on each vehicle, issues arise to efficiently monitor and detect cyber security attacks across a fleet of vehicles.

For example, a vehicle may be viewed as a connected device that relies on software for its functionality, and is surrounded by a digital ecosystem where in-vehicle network data is collected and sent. Electric vehicles (EVs) in particular, may rely heavily on software and network connectivity to properly function. With the growing market for EVs, the digital ecosystem of EVs and the EV itself are targets for threat actors. Similarly, traditional vehicles with internal combustion engines (ICEs) are also becoming more reliant on computing devices and network connectivity for functionality. As such, it is desirable to monitor vehicle behavior for anomalies (e.g., a cybersecurity threat and/or potential component failure), in a comprehensive and efficient manner.

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

With the fast evolving technology of EVs and differences in the type of data that are collected and processed from each EV to a dedicated network (e.g., an in-vehicle network), existing cybersecurity monitoring solutions are not aligned with the requirement for monitoring of vehicles.

Aspects of the present disclosure relate to a vehicle security monitoring platform that may monitor a vehicle's digital systems to detect cyber anomalies, such as unauthorized access or unusual data patterns. By analyzing network traffic within the vehicle or to and from the vehicle, as well as vehicle system behavior (e.g., based on log data), the vehicle security monitoring platform is capable of identifying potential threats as they occur (e.g., in real time or minimal delay). When an anomaly is detected, the platform may promptly generate an alert, which may be sent to a dashboard or other vehicle security tool, for immediate action. This proactive approach mitigates risks and protects the vehicle systems against cyber-attacks. The platform quickly addresses suspicious activity, thereby enhancing overall vehicle safety and security.

In an aspect a method comprises: receiving data associated with a vehicle, the data comprising one or more logs associated with the vehicle and telemetry data generated by the vehicle; detecting a data anomaly associated with the vehicle, including applying at least a machine learning model to the data; in response to detecting the data anomaly to the vehicle, performing a remediation action; and storing the data anomaly in memory.

In an embodiment, the method comprises training the machine learning model with unlabeled training data, including training the machine learning model to detect a reoccurring pattern between the one or more logs associated with the vehicle and the telemetry data generated by the vehicle.

In an embodiment, training the machine learning model comprises training a plurality of machine learning models with the unlabeled training data, selecting a subset of the plurality of machine learning models based on a performance metric associated with each of the plurality of machine learning models, and displaying the subset of machine learning models.

In an embodiment, training the machine learning model further comprises applying labeled test data to the subset of machine learning models; and selecting the machine learning model from the subset of machine learning models based on a difference between output of each of the subset of machine learning models and the labeled test data.

In an embodiment, selecting the subset of the machine learning models comprises ranking the machine learning models based on the performance metric, wherein the performance metric is associated with a cluster quality of the unlabeled training data by each of the plurality of machine learning models.

In an embodiment, performing the remediation action comprises determining a current driving scenario associated with the vehicle; determining a category of the data anomaly. In response to the current driving scenario and the category of the data anomaly satisfying a condition, the method may cause a notification through a first device that is external to the vehicle; and in response to the current driving scenario and the category of the data anomaly satisfying a second condition, the method may cause a second notification through a human machine interface that is internal to the vehicle. In an embodiment, the condition comprises that the vehicle is stationary and the data anomaly is categorized as a security threat. In an embodiment, the second condition comprises that the vehicle is moving and the data anomaly is categorized as affecting driving of the vehicle.

In an embodiment, detecting the data anomaly further comprises applying a condition-based rule to the data which detects a second data anomaly or detects the same data anomaly detected by the machine learning model. In an embodiment, the method further comprises storing an indication of each instance the condition-based rule detected a second data anomaly that the machine learning model does not detect, or storing an indication of each instance that the machine learning model detected the data anomaly that the condition-based rule does not detect, or storing a third indication of each instance that both the machine learning model and the condition-based rule detect the same data anomaly, or storing all such indications.

In an embodiment, the one or more logs comprises at least one of an electronic control unit (ECU) log, and over-the-air (OTA) log, and application programming interface (API) log, a virtual private network (VPN) log, a mobile gateway log or other log.

In an embodiment, the telemetry data comprises a plurality of signals communicated over a bus of the vehicle, the plurality of signals comprising at least one of: a vehicle controller status, a vehicle operational status, a drive command, a network connectivity status, a sensed environmental condition, or a vehicle location.

In an embodiment, the machine learning model resides on a computing device that is external to the vehicle. In an embodiment, a second machine learning model with a smaller memory footprint or a smaller throughput than the machine learning model is deployed to a second computing device that is internal to the vehicle.

In an embodiment, the anomaly comprises at least one of an over-the-air (OTA) anomaly, a Message Queuing Telemetry Transport (MQTT) anomaly, an Advanced Driver Assistance System (ADAS) anomaly, a vehicle electronic control unit (ECU) operating system anomaly, or a virtual private network (VPN) anomaly.

In an embodiment, the anomaly comprises a vehicle charging anomaly, a vehicle sensor anomaly, or a vehicle key fob anomaly.

In an aspect, the operations performed with respect to the method are performed by a computing device. In an aspect, a non-transitory computer readable memory stores machine executable instructions that, when executed by a processing device, causes the operations of the method to be performed.

Other technical features may be readily apparent to one skilled in the art from the following figures, descriptions, and claims.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 shows an example of a vehicle cybersecurity monitoring system, in accordance with an embodiment.

FIG. 2 shows an example diagram of a vehicle cyber security monitoring system, in accordance with an embodiment.

FIG. 3 shows an example workflow for machine learning model generation and deployment, in accordance with an embodiment.

FIG. 4 shows an example of a vehicle cyber security monitoring system, in accordance with an embodiment.

FIG. 5 shows a flow diagram of a method for detecting an anomaly associated with a vehicle, according to an embodiment.

FIG. 6 is an example of a computer system that may perform operations described, in accordance with an embodiment.

FIG. 7 is a high-level view of some embodiments of a vehicle, in accordance with an embodiment.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “transmitting”, “storing”, “determining”, “accessing”, “referencing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

With the fast evolving technology of EVs and differences in the type of data that are collected and processed from each EV to a dedicated network (e.g., an in-vehicle network), existing cybersecurity monitoring solutions are not aligned with the requirement for monitoring of vehicles.

Aspects of the present disclosure relate to a vehicle security monitoring platform that may continuously monitors a vehicle's digital systems to detect cyber anomalies, such as unauthorized access or unusual data patterns. By analyzing network traffic within the vehicle or to and from the vehicle, as well as vehicle system behavior, the vehicle security monitoring platform is capable of identifying potential threats as they occur (e.g., in real time or minimal delay). When an anomaly is detected, the platform may promptly generate an alert, which may be sent to a dashboard or other vehicle security tool, for immediate action. This proactive approach mitigates risks and protects the vehicle systems against cyber-attacks. The platform quickly addresses suspicious activity, thereby enhancing overall vehicle safety and security. The platform may monitor data on the in-vehicle network, and perform alert monitoring, triage, and management of end-to-end processes.

In comparison with existing systems, the vehicle cybersecurity monitoring platform provides a more comprehensive and proactive approach to vehicle cybersecurity. Unlike existing solutions that may offer limited or reactive protection, aspects of the present disclosure deliver continuous, real-time security monitoring of vehicles. Such a platform enhances threat detection capabilities through advanced anomaly detection algorithms and utilizes AI-based models to efficiently detect potential cyber threats on the vehicle. This proactive and integrated approach significantly improves the overall safety, reliability, and security of modern connected vehicles, addressing the growing complexity and connectivity of automotive systems that are not adequately protected by existing technologies.

Aspects of the present disclosure describe a method and system that leverages multiple data sources and machine learning with an unsupervised or semi-supervised training approach, to address cybersecurity risks to vehicles on a network.

In an embodiment, the system may use a hybrid approach of condition-based rule analysis and one or more machine learning models to identify potential cybersecurity risks. In an embodiment, the system may utilize human-in-the-loop training of the machine learning models.

In an embodiment, the multiple data sources includes log data (e.g., in human readable form) from one or more sources, as well as non-log data such as vehicle telemetry. The vehicle telemetry may include real-time status of signals on a vehicle (e.g., throttle state, cabin temperature, brake state, motor state, battery data (e.g., SOC, SOH, temperature, etc.), service statuses, etc., which may be pulled of one or more vehicle communication buses (e.g., a CAN bus, etc.).

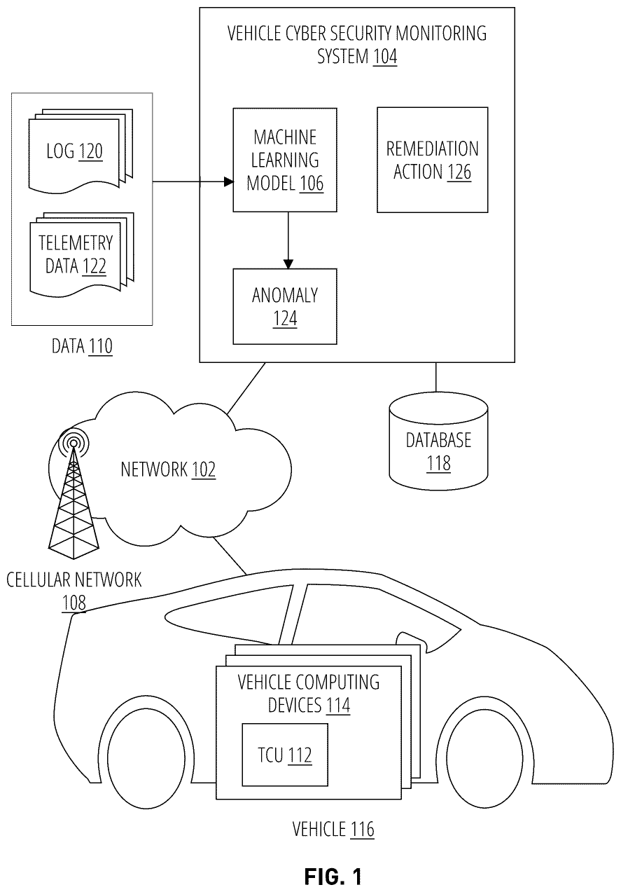

FIG. 1 shows an example of a vehicle cybersecurity monitoring system, in accordance with an embodiment. In an embodiment, the vehicle cyber security monitoring system 104 may be communicatively coupled to one or more vehicles 116, over a computer network 102. In an embodiment, the vehicle cyber security monitoring system 104 may monitor a plurality of vehicles 116 (e.g., a fleet).

Network 102 may comprise transmitters, receivers, network switches, routers, firewalls, cables, etc. Network 102 may include a wide area network (WAN), a local area network (LAN), and/or the public internet. Network 102 may include one or more cellular networks 108 such as a second generation (2G) cellular network, global system telecommunications (GSM), long-term evolution (LTE), new radio (NR), or other cellular network. Generally, each of the computing devices or components thereof described in the present disclosure may communicate with each other over network 102 using one or more communication protocols such as, for example, transmission control protocol/internet protocol (TCP/IP), a cellular network protocol, or other communication protocol.

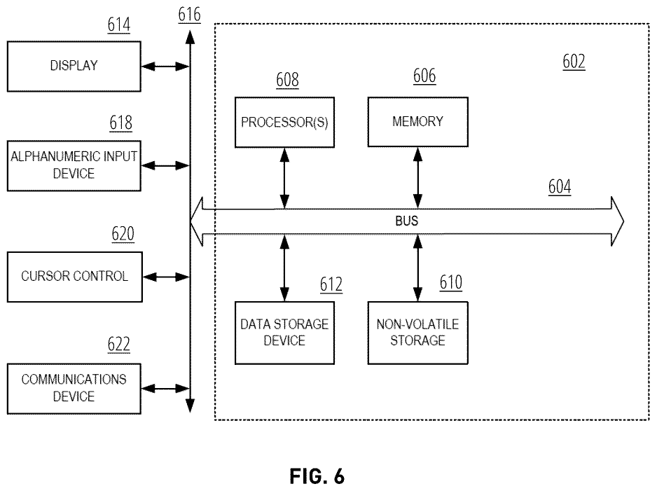

Vehicle 116 may comprise onboard vehicle computing devices 114, such as, for example, a telematics control unit (TCU) 112, and other vehicle computing devices 114 each represent one or more computing devices. The TCU 112 and other vehicle computing devices 114 may be communicatively coupled to the computer network 102. Examples of other vehicle computing devices 114 can be found for example, in FIG. 6. These devices may communicate with each other or to the TCU 112 within the vehicle 116 over one or more communication buses (e.g., CAN bus, etc.). Some or all these communications, which may also be referred to as signals, may be timestamped and recorded along with a status (e.g., a status of a signal, of a device, a condition, etc.).

Vehicle cyber security monitoring system 104 may comprise one or more computing devices which are coupled to network 102. Vehicle cyber security monitoring system 104 may receive data 110 that is associated with vehicle 116. The data 110 may comprise one or more logs 120 that are associated with the vehicle 116 and telemetry data 122 that are generated by the vehicle 116.

Generally, the one more logs may be generated by computing devices onboard the vehicle 116 or by computing devices in communication with vehicle 116, or a combination thereof. The log files may be generated as human readable text documents, and stored in computer memory. Each log may comprise a list of events logged by the corresponding computing device, and corresponding metadata (e.g., status, time of logging, category, criticality, etc.).

In an embodiment, the one or more logs comprises an electronic control unit (ECU) log, generated by an ECU of vehicle 116. In an embodiment, the one or more logs 120 comprises an over-the-air (OTA) log, generated by an onboard computing device of vehicle 116 or an external computing device, or both, relating to an OTA session and containing events that occurred during the OTA session (e.g., a connection, an authentication, an upload, a download, a disconnection, a request, a response, etc.). In an embodiment, the one or more logs 120 comprises an application programming interface (API) log, a virtual private network (VPN) log, or a mobile gateway log. In an embodiment, the one or more logs comprises at least one of the mentioned logs, or a combination thereof, such as, for example, all of the mentioned logs.

In an embodiment, the telemetry data 122 comprises signals communicated over a bus of the vehicle. A vehicle bus may comprise a CAN bus, a local area network (LAN) or local interconnect network (LIN) of the vehicle 116, or other communication bus or combination thereof. The plurality of signals may comprise a vehicle controller status (e.g., normal, abnormal, fault, etc.), a vehicle operational status (e.g., drive, park, reverse, etc.), a drive command (e.g., throttle, steering, brake, etc.), a network connectivity status (e.g., connected, not connected, an IP address, etc.), a sensed environmental condition (e.g., temperature, speed, sensed external objects, etc.), or a vehicle location (e.g., on a virtual map, geocoordinates, etc.). Each signal may have corresponding metadata such as a timestamp of signal origination and a signal originator (e.g., one of the onboard computing devices of the vehicle 116).

Vehicle cyber security monitoring system 104 may detect a data anomaly associated with the vehicle 116, including applying at least a machine learning model 106 to the data 110. Machine learning model 106 may comprise a machine learning algorithm that is trained to detect a pattern between the one or more logs associated with the vehicle and the telemetry data generated by the vehicle. In an embodiment, the machine learning model 106 is trained to detect a pattern of data (e.g., a threat signature) that spans across at least one of the logs and at least one of the signals from vehicle telemetry data 122. The training phase of machine learning model 106 is described further in other sections.

The machine learning model 106 may comprise at least one of a plurality of different machine learning models such as, for example, a random forest, an isolation forest, a support vector machine (SVM), an artificial neural network such as a recurrent neural network, a long short-term memory network, a convolutional neural network, or other artificial neural network, a logistic regression model, a K-means clustering model, a Bayesian network, a density-based spatial clustering of applications with noise (DBSCAN), or other machine learning model. In an embodiment, the machine learning model 106 is selected from a plurality of machine learning models (e.g., different machine learning models) such as those mentioned above, based on metrics and/or performance, as described in other sections.

In response to detecting the data anomaly 124 to the vehicle, the vehicle cyber security monitoring system 104 may perform a remediation action 126. The vehicle cyber security monitoring system 104 may store the anomaly 124 in memory (e.g., an electronic storage medium).

In an embodiment, to perform the remediation action 126, the vehicle cyber security monitoring system 104 may determine a current driving scenario associated with the vehicle 116, determine a category of the data anomaly 124, and generate the proper remediation action 126 based on the current driving scenario (e.g., moving, stationary, parking, a vehicle location being home, vehicle currently charging, a vehicle speed being above or below a threshold, etc.).

In an embodiment, in response to the current driving scenario and the category of the data anomaly satisfying a condition, vehicle cyber security monitoring system 104 may cause a notification through a first device that is external to the vehicle. In an embodiment, the condition may that the vehicle is stationary and the data anomaly is categorized as a security threat.

For example, vehicle cyber security monitoring system 104 may detect that vehicle 116 is stationary based on telemetry data 122, based on the current sensed speed of the vehicle, and/or other signals such as vehicle state being in ‘parked’, or vehicle control commands (e.g., throttle, brake, steering), or a combination thereof. Vehicle cyber security monitoring system 104 may categorize each anomaly 124 based on matching the detected pattern of the input data to a signature that is associated with the category. The categorization of an anomaly 124 may be determined by machine learning model 106, analyst input, a condition-based rule, or a combination thereof. In response, to detecting that the vehicle is stationary and that the anomaly 124 relates to a potential security breach (e.g., a cyber security threat, malware, or a physical breach of the vehicle 116), the vehicle cyber security monitoring system 104 may transmit a message over network 102 to a mobile device or computing device of a user through that is associated with the vehicle. This may be transmitted through network 102 over a short message service (SMS), or through email, or other electronic transmission protocol or combination thereof.

Additionally, or alternatively, in response to the current driving scenario and the category of the data anomaly satisfying a second condition, vehicle cyber security monitoring system 104 may cause a second notification through a human machine interface (HMI) that is internal to the vehicle 116. The HMI may comprise an electronic display, a light indicator, a speaker/sound system, or other HMI component which may be integrated within a cabin of the vehicle to alert users within the vehicle. In an embodiment, the second condition comprises that the vehicle is moving and the data anomaly is categorized as affecting driving of the vehicle.

For example, vehicle cyber security monitoring system 104 may determine based on the telemetry data 122 that the vehicle is moving, based on the current sensed speed of the vehicle, and/or other signals such as vehicle state being in an unparked state, or active vehicle control commands (e.g., throttle, brake, steering), or a combination thereof. The anomaly 124 may be categorized as being related to driving (e.g., a failure or security breach related to a predefined list of vehicle components such as sensors, actuators, or computing devices that performing operations that affect movement of the vehicle). In response to the second condition being satisfied, the vehicle cyber security monitoring system 104 may transmit a message to vehicle 116 to cause the vehicle to present an alert (e.g., a display, light, sound, or combination thereof) through the vehicle HMI.

In such a manner, the vehicle may tailor the remediation action 126 based on the current state of the vehicle, and based on the category of the anomaly 124. In cases where the vehicle is moving and the anomaly 124 relates to driving, the vehicle cyber security monitoring system 104 beneficially causes the corresponding alert to be presented to a user within the vehicle 116, so that the user may take necessary action such as stopping the vehicle, or taking the vehicle to a specialist for further diagnosis. In the case where the vehicle is stationary and the anomaly is security related, the vehicle cyber security monitoring system 104 sends a message to a corresponding vehicle user, assuming that the user is likely not near the vehicle due to its lack of movement, so that the now notified user can take further action such as confirming whether the vehicle is under a physical or cyber security threat.

In an embodiment, the anomaly 124 may be stored in a log file. Additionally, or alternatively, the anomaly 124 may be stored in a database 118 which may be a structured database. In an embodiment, each anomaly 124 may be stored with respect to the corresponding vehicle on a per vehicle basis, and with a respective timestamp and/or other metadata such as a machine learning model identifier or condition-based rule that detected the anomaly 124, or which of the data in the one or more logs 120 and/or telemetry data 122 correspond to the detected anomaly 124.

In an embodiment, machine learning model 106 resides on a computing device that is external to the vehicle. For example, the machine learning model 106 as well as parts or all of the vehicle cyber security monitoring system 104 may be hosted on a cloud-based server that is coupled to network 102. Vehicle cyber security monitoring system 104 may comprise a monolithic computing architecture (e.g., a single application), or a distributed architecture comprising multiple services hosted across a plurality of different computing devices that communicate over the network 102 to perform functionality of the vehicle cyber security monitoring system 104.

Additionally, or alternatively, machine learning model 106 or a second machine learning model (not shown) may be deployed and hosted on a computing device that is on the vehicle 116. For example, machine learning model 106 or a second machine learning model may be deployed to one of the onboard computing devices of vehicle 116, and process one or more logs 120 and telemetry data 122 of the vehicle 116. In an embodiment, the second machine learning model that is deployed onboard the vehicle may comprise a smaller memory footprint or a smaller throughput than the machine learning model 106 that is deployed external to the vehicle. The second machine learning model may process a subset of the data that the machine learning model 106 processes, to use the limited resources of the second machine learning model for data that is deemed to be more critical to vehicle anomaly detection, such as data that may historically have a higher correlation to detecting a cyber security threat and/or vehicle safety.

In an embodiment, the onboard machine learning model 106 or second machine learning model may be updated periodically or on an event-basis, or both, through an OTA update. Updates may be performed automatically.

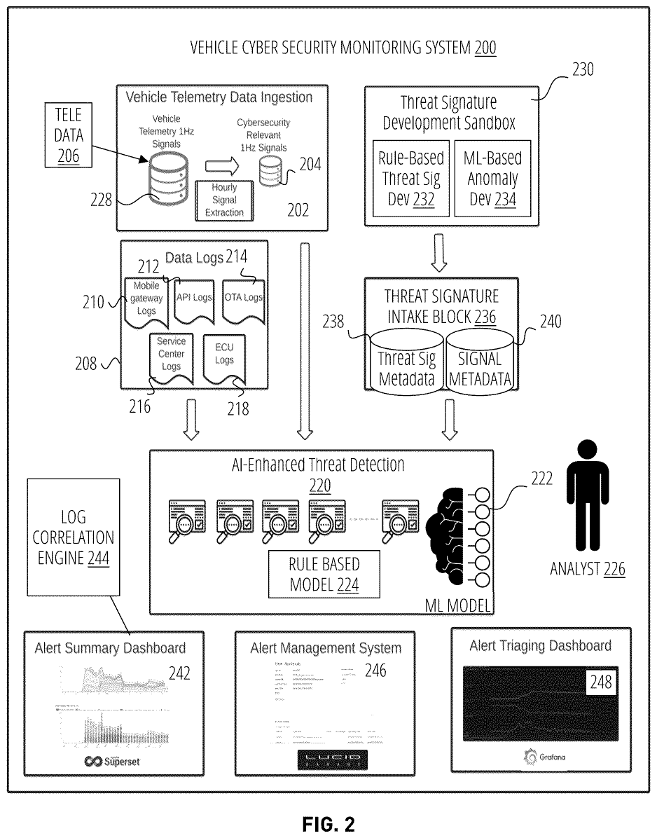

FIG. 2 shows an example diagram of a vehicle cyber security monitoring system, in accordance with an embodiment. Generally, the vehicle cyber security monitoring system 200 may obtain data associated with one or more vehicles to identify a potential cyber security threat to a vehicle, based on the data. The vehicle cyber security monitoring system 200 may comprise AI and machine learning components to detect anomalous or suspicious behavior of the vehicles, potentially resulting from an impending security threat. Vehicle cyber security monitoring system 200 may comprise features described with respect to vehicle cyber security monitoring system 104, or with respect to routine 200. For example, telemetry data 122 may correspond to telemetry data 206. Similarly, one or more logs 120 may correspond to data logs 208.

The vehicle cyber security monitoring system 200 serves as an intelligent end-to-end vehicle cybersecurity monitoring platform that enables a network service tool (e.g., a Vehicle Security Operations Center (VSOC)) to proactively mitigate security attacks on vehicles which may be potentially located across different geographical regions. In an embodiment, at block 202, the vehicle cyber security monitoring system 200 ingests vehicle telemetry data 206. The vehicle cyber security monitoring system 200 receives a flow of telemetry data 206 from one or more vehicles (e.g., over a network), and prepares this telemetry data 206 for the detection systems in vehicle cyber security monitoring system 200. At vehicle telemetry data ingestion block 202, the vehicle cyber security monitoring system 200 may collect and analyze telemetry data transmitted from one or more vehicles. In an embodiment, the telemetry data may comprise one or more signals, such as a vehicle command, service, or controller, etc. The telemetry data 206 may comprise a status associated with each signal (e.g., a sensed value, a current state (e.g., a sensed state or vehicle operational state). Each signal may comprise a timestamp of when the signal is generated or received.

For example, telemetry data 206 may comprise signals from various Electronic Control Units (ECUs) within the vehicles which are reported to the backend cloud and to vehicle cyber security monitoring system 200. Vehicle cyber security monitoring system 200 may group signals into Protocol Data Units (PDUs) based on the type and functionality. When one or more signals within a group is updated (e.g., changed with respect to the last set of values from the group), the Telematic Control Unit (TCU) of a vehicle may queue up the telemetry for the changed PDU to be uploaded to the cloud (and to the vehicle cyber security monitoring system 200). This queue may be populated in a first in first out (FIFO) order. Raw telemetry signals may be processed and stored in a database 228.

In an embodiment, database 228 may comprise a database (e.g., Trino, etc.). Additionally, or alternatively, the data 206 may be stored with an iceberg format or other structured database format, that tracks and organizes large datasets. In an embodiment, a plurality of cybersecurity-relevant signals (e.g., 250 or more) may be retrieved from this database at an hourly cadence and stored in a well-partitioned database that is optimized for fast and efficient down-stream detection processes.

In an example, the vehicle telemetry data may be generated by a vehicle at a periodic rate (e.g., 1 Hz, 5 Hz, etc.). The vehicle cyber security monitoring system 200 may extract the vehicle telemetry data from each vehicle in an event driven manner, and/or periodically (e.g., every hour, daily, etc.). In an embodiment, the vehicle cyber security monitoring system 200 may store some or all of these signals in a database 204. In an embodiment, the vehicle cyber security monitoring system 200 may filter out signals deemed to be irrelevant (e.g., based on the status of the signals, one or more filtering rules, and one or more thresholds).

The vehicle cyber security monitoring system 200 may obtain one or more data logs 208. The data logs 208 may include, for example, at least one or more of: mobile gateway logs 210, API logs 212, OTA logs 214, service center logs 216, or ECU logs 218, or a combination thereof. The mobile gateway logs 210 may comprise logs generated by an API gateway that secures communication between a mobile app and backend resources. API logs 212 may be generated by a supporting device where the log comprises a record of all API requests and responses that the supporting device receives or transmits using a given API. OTA logs 214 may comprise one or more, or all, of the events and activities that occur during an over-the-air (OTA) update. ECU logs 218 may comprise one or more events generated by an electronic control unit (ECU) of a respective vehicle, and so on.

At real-time threat detection block 220, vehicle cyber security monitoring system 200 may utilize one or more ML models 222 to process log data 208, and the vehicle telemetry data 206. The vehicle cyber security monitoring system 200 may apply a trained machine learning model 222 to the log data 208 and the vehicle telemetry data 206. The trained machine learning model 222 correlates anomalous data patterns within the telemetry data, and/or with other data logs, to detect one or more security-critical events. In response to detecting security-critical behavior, vehicle cyber security monitoring system 200 may perform a remediation action (e.g., remediation action 126). The vehicle cyber security monitoring system 200 may generate an alert immediately. In addition, vehicle cyber security monitoring system 200 may present (e.g., display) one or more relationships or conditions associated with an alert, which enables alert triaging such as for an analyst 226 to examine these relationships and/or conditions and identify the root-cause associated with a given alert.

The vehicle cyber security monitoring system 200 may include a threat signature intake development sandbox 230 that includes functionality for training, selecting, or tuning machine learning models for deployment. Vehicle cyber security monitoring system 200 supports development and deployment of different types of models, such as rule based model 224 and ML model 222. Vehicle cyber security monitoring system 200 may comprise a graphical user interface (not shown) with user controls to receive input that vehicle cyber security monitoring system 200 uses to generate a rules based threat signature model 224, or a machine learning model 222, or both.

Rule based threat signature model 224 may comprise a set of heuristics or conditions to detect security-critical events associate with a vehicle. It may comprise one or more dedicated processing threads that process the signals 204 and logs 214 to check for satisfaction of the conditions. When those conditions are met, the rule based threat signature model 224 may generate an alert. The conditions for a given rule based threat signature model 224 may be defined by an analyst 226. Unlike rule-based threat signature models, the threat signature conditions for ML-models 222 may be automatically derived from data through statistics and machine learning. By incorporating intelligence into the detection systems, the vehicle cyber security monitoring system 200 may achieve higher precision in the detected threats and minimize the number of false alarms as compared to rule-based detection systems.

Within a rule-based threat signature development pipeline 232, a security analyst 226 may design and develop rule-based models 224 that each detect a specified threat signature, addressing various security scenarios. The vehicle cyber security monitoring system 200 may receive one or more inputs from security analyst 226 which define a security scenario and/or detection conditions that form the specified threat signature, through quick, systematic, and iterative experimentation within the development sandbox 230. For example, sample telemetry data 206 from the ingestion pipeline may be channeled to the sandbox and simulated against a proposed rule based threat signature model. The security analyst 226 can specify the rule-based threat signature model behavior via a simple user-interface loaded with a pre-defined generic template. In an embodiment, the threat signature (e.g., a combination of one or more conditions) may include a low-level event where the relevant signals attain critical signal states (e.g., a threshold). This may be followed by a condition to check whether the low-level event has been triggered significant number of times within a well-defined aggregation window. Additionally, the rule-based threat signature model may include conditions to check within the telemetry data or log data, for whether the rule-based threat signature model behavior can be analyzed on sample test-data and modified to meet the requirements of the security use-case in an iterative manner. Additionally, vehicle cyber security monitoring system 200 may generate and show graphical representation of time-series data of all the relevant signals and the timeline of the anomalous events detected.

ML development pipeline 234 may comprise various operations following the definition of security scenarios generated by the analysts. These operations are streamlined with the help of a complex machine learning training algorithms that support a wide range of ML models and security scenarios. The module comprises pre-defined methods that enable fast and efficient machine learning development and deployment, with a user-friendly interface.

In an embodiment, ML development pipeline 234 may include feature preparation. During feature preparation, vehicle cyber security monitoring system 200 may identify relevant signals for an underlying scenario and perform data transformations (e.g., converting the raw data into a feature vector focusing value ranges of a particular characteristic in the data) to enable effective machine learning. The transformed raw signals or features are given as an input to ML model 222. The machine learning model training algorithms supports a wide range of feature standardization and feature selection approaches. Feature importance analysis and dimensionality reduction are also enabled via multiple techniques readily accessible. An optimal combination of input features is evaluated and provided to the ML model 222 to ensure the detection context is captured in a sufficient or optimized manner.

In ML development pipeline 234, vehicle cyber security monitoring system 200 may have stored a rich repository of ML algorithms that may be presented to an analyst 226 for selection. The vehicle cyber security monitoring system 200 may comprise built-in methods to identify a suggested or optimal configuration of hyper-parameters for each ML algorithm. These hyper-parameters are parameters in a machine learning algorithm that are set before training a model and control how model learns (e.g., clustering or categorizing different data), and affects the model's performance. Hyper-parameters may include, for example, a model architecture hyper parameter such as, for example, the number of layers and nodes in a neural network; a learning rate of the model; a model complexity such as the number of branches in a decision tree; a regularization strength; a dropout rate; or other machine learning hyper-parameter.

The vehicle cyber security monitoring system 200 may train one or more ML models 222. Once each ML algorithm is trained, the vehicle cyber security monitoring system 200 may present the analyst 226 with controls and data to evaluate the efficacy of each model on a test data set and compare the performance amongst other candidate ML algorithms. Standard evaluation metrics are available to choose from, supporting both unsupervised and semi-supervised ML algorithms. Based on the evaluation results, the optimal ML model is selected at the end of this stage.

Within ML development pipeline 234, vehicle cyber security monitoring system 200 may perform ML model tracking and registry. The vehicle cyber security monitoring system 200 may support several alternative MLs including standard or existing tools (e.g., MLFlow) for tracking and registry of trained models and other artifacts. Using the integrated ML-based software tools in vehicle cyber security monitoring system 200, the analyst 226 can understand insights about a given model including the features, evaluation metrics, training hyperparameters, model configuration, etc. Additionally, vehicle cyber security monitoring system 200 may log artifacts such as feature preparation pipelines for improved retrieval during inference. After training and selection, the behavior of an ML model is validated from the cybersecurity domain perspective. Vehicle cyber security monitoring system 200 may apply one or more tools such as SHAP (SHapley Additive exPlanations), PCA, 3D-plots, and histograms to explain the model behavior and outcomes.

At threat signature intake block 236, vehicle cyber security monitoring system 200 adds new models (e.g., ML model 222 and/or rule based model224), upgrades existing models, or both. In an embodiment, vehicle cyber security monitoring system 200 may automatically update existing deployed models, or automatically add new models, or both. The vehicle cyber security monitoring system 200 may define and store a generic template that captures metadata associated with each model so that any new model added to the platform can also be represented using the same template.

For example, at threat signature intake block 236, vehicle cyber security monitoring system 200 may store threat signature model metadata 238 in a repository. This repository may store all the threat signature models and their attributes including the owner of the model (e.g., an analyst 226), a unique code and name assigned to the model, a threat signature condition (or set of conditions) used to capture the security-critical events, aggregation requirements (e.g., a threshold number of times the condition is met), etc. This is stored in a database accessible by the detection software modules when executing the hourly threat detection jobs. Similarly, signal metadata 240 may be stored in a respective repository of all the cybersecurity-relevant signals used by the threat detection models (222, or 224, or both) within vehicle cyber security monitoring system 200.

Real-time threat detection block 220 comprises one or more rule based models 224 and one or more ML models 222. The rule based model 224 and ML model 222 may be scheduled to run at a defined cadence (e.g., hourly, etc.) to capture anomalous events and triggering alerts. In an embodiment, real-time threat detection block 220 may be sit on a dedicated host platform (e.g., Apache Airflow and/or Amazon Web Services (AWS)). The entire spectrum of rule based model 224 and/or ML model 222 may be grouped into small clusters and deployed together for efficiency and to meet the strict timing requirements for detection, i.e., to detect threats within one hour of data being available on cloud. A dedicated job (e.g., a computing task with dedicated processing and memory resources) may be scheduled to run every hour for extracting cybersecurity-relevant signals from the vehicle signals database. Subsequently, the jobs for detecting security threats may be automatically executed every hour, after the signal extraction is successful. The backend for threat detection may be developed to perform various operations including low-level event detection followed by post-processing over specified time intervals and fleet-level aggregations to trigger security alerts. These alerts may be stored in a dedicated database that feeds into all the dashboards and alert management systems with unique alert IDs assigned to them as the primary key. The start and end timestamps of the alert, affected asset ID or the Vehicle Identification Number (vin), the alert type, additional details/comments, etc., are stored in this database for each alert.

In an embodiment, vehicle cyber security monitoring system 200 comprises an alert summary dashboard 242. The alert summary dashboard 242 may comprise a visualization tool (e.g., one or more displayed graphs). The alert summary dashboard 242 may display a summary of alert counts (e.g., daily, weekly, and/or monthly), the distributions of alerts by type, trend of alert counts over time, etc., or a combination thereof. These summary stats can be viewed for a specified time range, alert types, as well as affected vehicles.

In an embodiment, vehicle cyber security monitoring system 200 may comprise a log correlation engine 244. The log correlation engine 244 may correlate the logs 208 from different sources like vehicle microservices, telemetry data, and ECU (Electronic Control Unit) to connect the dots and map a specific chain of events to identify a cyber security incident. With the related information, vehicle cyber security monitoring system 200 may generate a customized alert and display this to 242 along with the timestamp of occurrence and vehicle id etc.

In an embodiment, vehicle cyber security monitoring system 200 may comprise an alert management system 246. The alert management system 246 may comprise logic and control that perform actions in view of the alerts. For example, alert management system 246 may assign one or more alerts to a select analyst 226, and label the alert as being under investigation. The 246 may also label a given alert as false or as a true positive, and this may be stored in computer memory. 246 provides a full picture of all the alerts yet to be investigated (e.g., as a displayed list). The alert management system 246 may filter alerts by the type of alert, the alert timestamps, or even by the affected vehicle ids. Alert management system 246 may notify analysts of alerts. In an embodiment, 246 may record all actions automatically in a database for traceability and auditing.

In an embodiment, vehicle cyber security monitoring system 200 may comprise an alert triaging dashboard 248. Vehicle cyber security monitoring system 200 may present to the alert triaging dashboard 248, a history of events and a timeline of different alert histories for a specific vehicle. The vehicle cyber security monitoring system 200 may query the vehicle service status from one or more external systems such as, for example, a service or customer relations management platform, to reduce the alert fatigue for an analyst as part of automated false positive management. In an embodiment, vehicle cyber security monitoring system 200 may provide a redirect link for graphical visualization of the events specific to alert. This provides insight into potential root causes for the triggered alert and sheds light on whether a given alert was a false alarm.

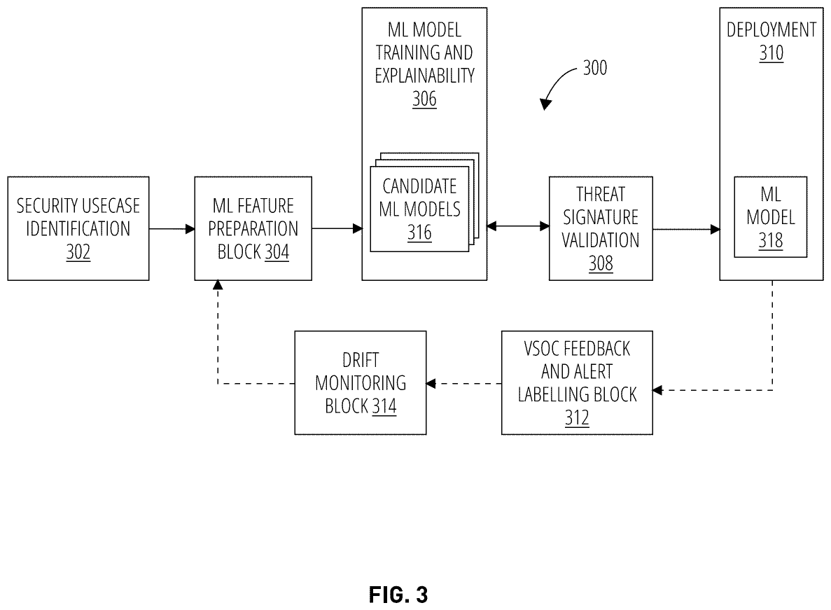

FIG. 3 shows an example workflow for machine learning model generation and deployment, in accordance with an embodiment. Workflow 300 may be performed by a vehicle cyber security monitoring system, as described in other sections.

At block 302, an analyst may identify one or more security use cases. For example, the workflow may include receiving one or more user inputs that select or define a security use case related to a cyber security threat to a vehicle.

At block 304, the workflow includes feature preparation. Feature preparation may include selecting characteristics in the data that are relevant to a given security use case. These characteristics may be formatted (e.g., as a feature vector) for ML training. The resulting formatted data may be referred to as training data.

At block 306, the system may train multiple machine learning algorithms with the training data. This may be referred to as unsupervised training. The training data may be unlabeled, meaning that during this unsupervised training phase, each ML model discovers patterns and relationships within the data on its own, such as by innately applying clustering algorithms to group similar data points together, without explicit guidance from labeled data. Although unlabeled, this training data is useful for anomaly detection, dimensionality reduction, and discovering hidden relationships within data. In an embodiment, the plurality of machine learning models may comprise different underlying machine learning algorithms (e.g., random forest, isolation forest, SVM, different artificial neural network (ANN)s, a logistic regression model, a K-means clustering model, a Bayesian network, DBSCAN, etc.) or the same machine learning algorithms but with different hyper-parameters, or both.

In an embodiment, at block 306, the system trains multiple ML algorithms with the same data, and then selects one or more best performing ML algorithms. These selected best performing ML algorithms may be referred to as a subset of the originally trained machine learning models, or candidate ML models 316.

In an embodiment, the system may select these candidate ML models 316 automatically based on one or more metrics, where the ML algorithms that have the best performance as indicated by the metric are selected. Additionally, or alternatively, the system may display the one or more metrics, and receive a user input (e.g., from an analyst through a UI), that manually selects the candidate ML models 316.

Given that unsupervised learning uses unlabeled training data, measuring performance of the trained ML models may be based on evaluating the quality of learned patterns or clusters through metrics. In an embodiment, one or more metrics measure the internal structure of data, cluster cohesiveness, separation between clusters, or a combination thereof. For example, the greater the separation or the more cohesive the clusters, the better (e.g., higher) the system measure the ML algorithm's corresponding metric. In an embodiment, the system may combine multiple metrics into a single metric. In an example, this may be based on a weighted average or weighted sum of the metrics. The system may generate these benchmarks for each ML model or an ML model tool that may be integrated within the vehicle cyber security monitoring system may generate these benchmarks, or a combination thereof. Example metrics may include a homogeneity, completeness, and V-measure that assess the consistency and completeness of the clustering; a within-cluster variance which measures the variance within each cluster, aiming for low values to indicate compact clusters; a Calinski-Harabasz Index, which measures the ratio of between-cluster variance to within-cluster variance, with higher scores indicating better-separated clusters; a Davies-Bouldin Index, which assesses the average similarity between each cluster and its most similar cluster, with lower scores indicating better-separated clusters; and/or a silhouette score, which measures how similar a data point is to its own cluster compared to other clusters, where higher scores indicate better-defined clusters. Other cluster-based metrics may be used by the system to rank/select the candidate ML models 316.

In an embodiment, at block 306, the system presents an explanation for one or more of the outputs of the trained ML algorithms. The explanation indicates the input data characteristics and values thereof that caused the ML model to draw the output (e.g., output of ‘anomaly X’ found due to signal A being above ‘x’ and signal B being in range ‘y-z’).

In an embodiment, the system displays the one or more best performing trained ML models (through unsupervised training), while displaying controls to perform additional actions such as performing additional training of the trained ML models with labeled data, and displaying results. In an embodiment, the results may indicate a difference between a desired output (e.g., the labeling of this additional training data) and the actual output of each candidate ML model.

At block 308, the workflow supports model validation. At this block, the system may present one or more controls indicating the candidate ML models 316, initially trained through unsupervised training, as well as the respective explanation for the outputs of the trained ML models. At this block, the system may receive one or more inputs from an analyst to test each of these selected ML models with additional training data. This may be labeled training data. The analyst may observe how accurate these ML models draw outputs based on the labeled training data. Further, the system may receive one or more inputs from the analysts to adjust an ML model (e.g., by adjusting a weight, a connection, a parameter, or a cost term, or a combination thereof), based on the provided explanation or the performance of the ML model in response to the labeled training data, or a combination thereof. The system may adjust the ML model accordingly, and the analyst may re-test the ML model. Additionally, or alternatively, the system may automatically apply one or more sets of labeled data to the candidate ML models 316 and select the best performing one of the candidate ML models 316 based on which minimized the difference between the desired output and the actual output. The system may validate one of the ML models for deployment, based on analyst selection, or automatically. Blocks 306 and 308 may represent a semi-supervised pipeline for training the ML models.

At block 310, the system deploys the selected ML model 318, which is the best performing one of candidate ML models 316. In an embodiment, the ML model 318 is made active on the network, where it is loaded on a network-connected device to receive and consume input data such as vehicle telemetry data and data logs, as described with respect to real-time threat detection block 220. In an example, the system may deploy multiple ML models 318. For example, a first ML model may be deployed to the cloud, and a second ML model may be deployed to an onboard system on a vehicle. In an embodiment, the first ML model may comprise a bigger memory footprint and/or a require a higher processing bandwidth than the second ML model that the system deploys to the vehicle.

Once deployed, the workflow 300 may continuously monitor and update deployed ML model 318. For example, at VSOC feedback and alert labelling block 312, a vehicle security operations center (VSOC) may continuously receive data logs and/or vehicle telemetry from vehicles that are in operation. VSOC may be integral or separate from a vehicle cyber security monitoring system, as described in other sections. VSOC may generate alerts indicating potential cybersecurity threats to a vehicle, and label data (e.g., the data logs and/or vehicle telemetry) that is associated with a given alert.

At drift monitoring block 314, this labeled feedback data may be applied to the deployed ML model 318 to determine a difference between the actual output of the ML model 318 and desired output (e.g., the label assigned to this data). Based on the difference between the actual and desired output, the workflow may proceed to ML feature preparation block 304 and prepare additional training data with extracted features that emphasize or target highlighted data from VSOC feedback and alert labelling block 312. The system may proceed to block 306 and generate new or adjusted candidate ML models 316 that are better trained to recognize anomalies (e.g., through clustering) related to new threats.

Unless explicitly calling out to an analyst or human, each of the operations performed by the vehicle cyber security monitoring system described in the present disclosure may be performed automatically (e.g., without human input or human guidance).

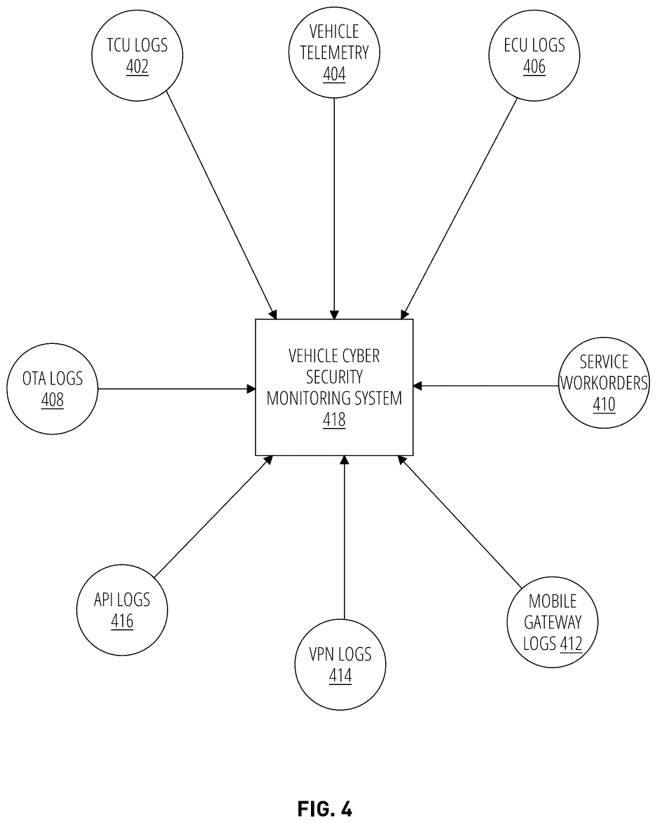

FIG. 4 shows an example of a vehicle cyber security monitoring system 418, in accordance with an embodiment. The vehicle cyber security monitoring system 418 may take input from multiple data sources, draw relationships between the different data sources for detecting cyber security threats posed to vehicles, while also using the data to develop threat signature models to detect these cyber security threats.

For example, a vehicle cyber security monitoring system 418 may comprise a machine learning model that is trained (e.g., with unsupervised training) with a combination of log data (e.g., TCU logs 402, ECU logs 406, OTA logs 408, mobile gateway logs 412, API logs 416, and VPN logs 414) in addition to non-log data such as, for example, vehicle telemetry 404 and service workorders 410.

As described, in other sections, vehicle cyber security monitoring system 418 may use machine learning models to detect patterns between the vehicle telemetry 404 and any one of the logs, to flag an anomaly. Such a system may more comprehensively detect vehicle-based anomalies by detecting patterns that from disparate sources of data that were previously not considered or monitored in existing systems.

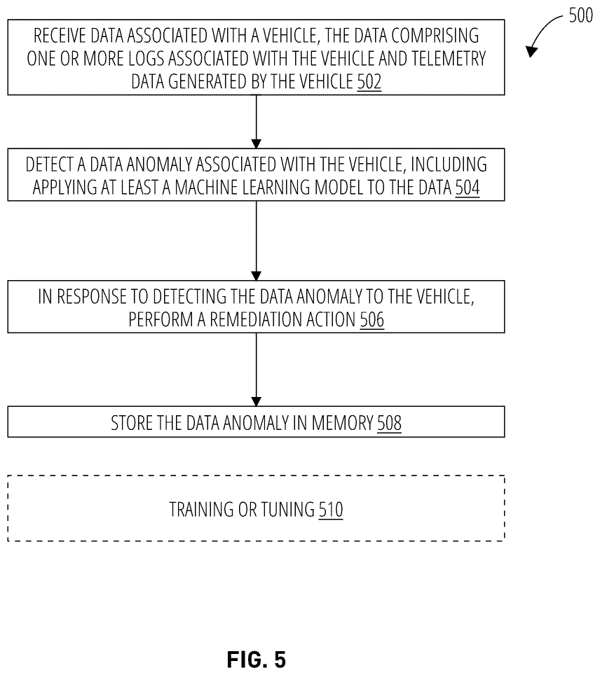

FIG. 5 shows a flow diagram of a method 500 for detecting an anomaly associated with a vehicle, according to an embodiment. The method 500 may be performed by processing logic that may comprise hardware (circuitry, dedicated logic, etc.), software (such as is run on a general purpose computer system or a dedicated machine), firmware, or a combination. The method 500 may be performed by a plurality of processors in a distributed architecture and/or a microservices architecture. Method 500 may be performed by a vehicle cyber security monitoring system, as described in other sections.

At block 502, processing logic receives data associated with a vehicle, the data comprising one or more logs associated with the vehicle and telemetry data generated by the vehicle. The one or more logs may comprise at least one of an ECU log, a TCU log, an OTA log, an API log, a VPN log, a mobile gateway log, or a combination thereof.

The telemetry data generated by the vehicle may comprise a signal communicated to or from an onboard computing device of the vehicle, such as, for example, a vehicle controller status (e.g., normal, abnormal, fault, etc.), a vehicle operational status (e.g., drive, park, reverse, etc.), a drive command (e.g., throttle, steering, brake, etc.), a network connectivity status (e.g., connected, not connected, an IP address, etc.), a sensed environmental condition (e.g., temperature, speed, sensed external objects, etc.), or a vehicle location (e.g., on a virtual map, geocoordinates, etc.), or signal.

At block 504, processing logic detects a data anomaly associated with the vehicle, including applying at least a machine learning model to the data. The machine learning model is trained to recognize a pattern in the one or more logs and the telemetry data, and in response to recognizing the pattern, generating an output indicating that an anomaly is detected.

In an embodiment, the anomaly comprises at least one of an over-the-air (OTA) anomaly, a Message Queuing Telemetry Transport (MQTT) anomaly, an Advanced Driver Assistance System (ADAS) anomaly, a vehicle electronic control unit (ECU) operating system anomaly, or a virtual private network (VPN) anomaly that is associated with the vehicle. In an embodiment, the anomaly comprises a vehicle charging anomaly, a vehicle sensor anomaly, or a vehicle key fob anomaly that is associated with the vehicle.

In an embodiment, at block 504, detecting the data anomaly further comprises applying a condition-based rule to the data which detects a second data anomaly or detects the same data anomaly detected by the machine learning model. In an embodiment, processing logic may use one of the condition-based rule or the machine learning model to improve the other.

For example, processing logic may store an indication of each instance the condition-based rule detected a second data anomaly that the machine learning model does not detect, or store an indication of each instance that the machine learning model detected the data anomaly that the condition-based rule does not detect, or store a third indication of each instance that both the machine learning model and the condition-based rule detect the same data anomaly, or all of the above. In an embodiment, these indication may be presented to an analyst to modify the existing machine learning model's hyper-parameters or select a new machine learning model algorithm for training, to train the new or existing machine learning model to detect the anomaly that was previously detected by the rule-based algorithm and not detected by the machine learning algorithm. Similarly, the analyst may generate a new condition-based rule based on analyzing instances where the machine learning model detected an anomaly but no condition-based rule detected the anomaly, so that such an anomaly is caught in the future by the new condition-based rule. Additionally, or alternatively, processing logic may automatically return the existing machine learning model, or retrain machine learning models (e.g., block 510) in response to when the machine learning model fails to detect an anomaly that is detected by the condition-based rule, until the trained machine learning model detects that anomaly during an automated test phase.

At block 506, in response to detecting the data anomaly to the vehicle, processing logic performs a remediation action. In an embodiment, performing the remediation action comprises determining a current driving scenario associated with the vehicle, determining a category of the data anomaly, in response to the current driving scenario and the category of the data anomaly satisfying a condition, causing a notification through a first device that is external to the vehicle; and in response to the current driving scenario and the category of the data anomaly satisfying a second condition, causing a second notification through a human machine interface that is internal to the vehicle. In an embodiment, the condition comprises that the vehicle is stationary and the data anomaly is categorized as a security threat. In an embodiment, the second condition comprises that the vehicle is moving and the data anomaly is categorized as affecting driving of the vehicle.

At block 508, processing logic stores the data anomaly in memory. The data anomaly can be stored in a structured database. The data anomaly may be stored with an association to a corresponding vehicle that generated the vehicle telemetry and is associated with the one or more logs.

In an embodiment, method 500 further comprises block 510, which may be performed prior to deployment of the machine learning model. Block 510 may also be performed after the machine learning model is deployed, to deploy an additional machine learning model, replace an existing machine learning model that is deployed, or tune the existing machine learning model.

At block 510, processing logic may train the machine learning model with unlabeled training data, including training the machine learning model to detect a pattern between the one or more logs associated with the vehicle and the telemetry data generated by the vehicle.

In an embodiment, training the machine learning model at block 510 comprises training a plurality of machine learning models with the unlabeled training data, selecting a subset of the plurality of machine learning models based on a performance metric associated with each of the plurality of machine learning models, and displaying the subset of machine learning models. This subset of machine learning models (e.g., candidate machine learning models) may be presented to an analyst for further testing. Each of the plurality of machine learning models may be different (e.g., have different hyper-parameters of a different machine learning algorithm).

In an embodiment, training the machine learning model at block 510 further comprises applying labeled test data to the subset of machine learning models, and selecting the machine learning model from the subset of machine learning models based on a difference between output of each of the subset of machine learning models and the labeled test data. In an embodiment, selecting the subset of the machine learning models comprises ranking the machine learning models based on the performance metric. In an embodiment, the performance metric is associated with a cluster quality of the unlabeled training data by each of the plurality of machine learning models. For example, during the training phase, each machine learning algorithm may evaluate the clustering of the data that the machine learning algorithm performs, and determine its performance metric based on measuring how close the model groups data points and based on the similarities and separation relative to other clusters. In an embodiment, processing logic may bypass the analyst, for example, by selecting the best ranked machine learning models and then automatically performing labeled testing of this subset of machine learning models. In an example, each of the blocks performed by processing logic are performed automatically.

FIG. 6 is an example embodiment of a computer system that may perform operations described, in accordance with an embodiment. For example, one or more computer systems as illustrated in FIG. 6 may be used by a vehicle cyber security monitoring system, as described in other sections. It will be apparent to those of ordinary skill in the art, however that other alternative systems of various system architectures may also be used.

The computer system 602 illustrated in FIG. 6 includes a bus or other internal communication means 604 for communicating information, and one or more processors 608 coupled to the bus 604 for processing information. The system further comprises a random access memory (RAM) or other volatile storage device 606 (referred to as memory), coupled to bus 604 for storing information and instructions to be executed by processor 608. Main memory 606 also may be used for storing temporary variables or other intermediate information during execution of instructions by processor 608. The system also comprises a read only memory (ROM), non-volatile storage, and/or static storage device 610 coupled to bus 604 for storing static information and instructions for processor 608, and a data storage device 612 such as a magnetic disk or optical disk and its corresponding disk drive. Data storage device 612 is coupled to bus 604 for storing information and instructions.

The system may further be coupled to a display device 614, such as a light emitting diode (LED) display or a liquid crystal display (LCD) coupled to bus 604 through bus 616 for displaying information to a computer user. An alphanumeric input device 618, including alphanumeric and other keys, may also be coupled to bus 604 through bus 616 for communicating information and command selections to processor 608. An additional user input device is cursor control device 620, such as a touchpad, mouse, a trackball, stylus, or cursor direction keys coupled to bus 604 through bus 616 for communicating direction information and command selections to processor 608, and for controlling cursor movement on display device 614.

Another device, which may optionally be coupled to computer system 602, is a communication device 622 for accessing other nodes of a distributed system via a network. The communication device 622 may include any of a number of commercially available networking peripheral devices such as those used for coupling to an Ethernet, token ring, Internet, or wide area network. The communication device 622 may further be a null-modem connection, or any other mechanism that provides connectivity between the computer system 602 and the outside world. Note that any or all of the components of this system illustrated in FIG. 6 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 606, mass storage device 612, or other storage medium locally or remotely accessible to processor 608.

It will be apparent to those of ordinary skill in the art that the system, method, and process described herein can be implemented as software stored in main memory 606 or read only memory and executed by processor 608. This control logic or software may also be resident on an article of manufacture comprising a computer readable medium having computer readable program code embodied therein and being readable by the mass storage device 612 and for causing the processor 608 to operate in accordance with the methods and teachings herein.

The embodiments discussed herein may also be embodied in a handheld or portable device containing a subset of the computer hardware components described above. For example, the handheld device may be configured to contain only the bus 604, the processor 608, and memory 606 and/or 612. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 608, a data storage device 612, a bus 604, and memory 606, and only rudimentary communications mechanisms, such as a small touch-screen that permits the user to communicate in a basic manner with the device. In general, the more special-purpose the device is, the fewer of the elements need be present for the device to function.

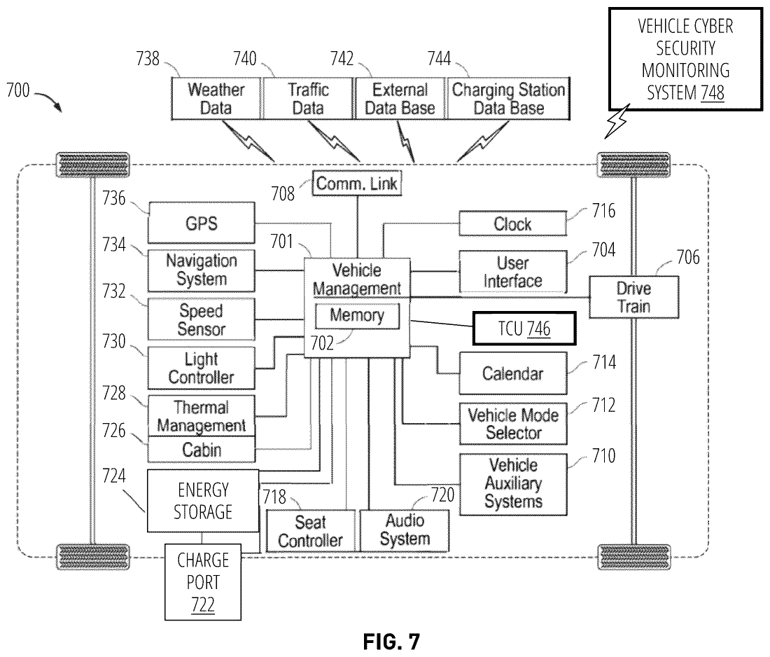

FIG. 7 is a high-level view of some embodiments of a vehicle 700, in accordance with an embodiment. Vehicle 700 can be an electric vehicle (EV), a vehicle utilizing an internal combustion engine (ICE), or a hybrid vehicle, where a hybrid vehicle utilizes multiple sources of propulsion including an electric drive system. Vehicle 700 includes a vehicle on-board system controller 701, also referred to herein as a vehicle management system, which is comprised of one or more processors (e.g., a central processing unit (CPU)). System controller 701 also includes memory 702, with memory 702 being comprised of EPROM, EEPROM, flash memory, RAM, solid state drive, hard disk drive, or any other type of memory or combination of memory types.

In some embodiments, vehicle 700 includes one or more internal networks by which system controller 701 interfaces and communicates with one or more internal subsystems of vehicle 700. System controller 701 can also use the one or more internal networks to transfer communications to and from external locations. In some embodiments, the one or more internal networks can be communicably coupled to one or more networks through a network interface. The network interface can provide for wired and/or wireless communication. When used in a local area networking environment (or a wide area networking environment), the network interface can include an Ethernet interface and the one or more internal networks includes an Ethernet communication network (e.g., an Ethernet Ring, etc.) with an Ethernet Port. Other possible embodiments use other communication devices. For example, in some embodiments vehicle 700 includes a modem for communicating across an internal network and/or with an external network.

In some embodiments, vehicle 700 includes a charge port 722 and one or more batteries (e.g., battery pack, etc.), and a battery charger, as an energy storage system 724 that provides power to portions of vehicle 700. The charge port 722 is used for providing voltage to vehicle 700 for charging the energy storage system 724 (e.g., charging batteries by the use of, for example, an EVSE or other power source in a manner well-known in the art. The charging port 722 can be used to transfer power from a battery of the energy storage system 724 to an external location as part of a vehicle-to-grid power transfer. In some embodiments, charging port 722 includes a communication path for communications between the system controller 701 and the locations external to vehicle 700 such as, for example, the power source providing power (voltage) to vehicle 700 for charging batteries of the energy storage system 724 and a utility distributed energy resource management system (DERMS) or an electric utility company and its facilities.

In some embodiments, energy storage system 724 includes an inverter that generates voltage for transfer to an electric power grid. In some embodiments, the inverter converts DC voltage to AC voltage for transfer to the electric power grid. In some embodiments, the same inverter (or a separate invertor) converts DC voltage to AC voltage for charging a battery of the energy storage system 724 or can provide DC to AC voltage conversion when providing power to an electrical power grid as part of a vehicle-to-grid operation. In the case of DC fast charging, the inverter may be bypassed to charge the battery pack directly with DC voltage from a charger that is connected to 722.

In some embodiments, vehicle 700 includes a user interface 704 is coupled to vehicle management system 701. Interface 704 allows the driver, or a passenger, to interact with the vehicle management system, for example inputting data into the navigation system 734, altering the heating, ventilation and air conditioning (HVAC) system via the thermal management system 726, controlling the vehicle's entertainment system (e.g., radio, CD/DVD player, etc.), adjusting vehicle settings (e.g., seat positions, light controls, etc.), and/or otherwise altering the functionality of vehicle 700. In some embodiments, user interface 704 also includes means for the vehicle management system to provide information to the driver and/or passenger, information such as a navigation map or driving instructions (e.g., via the navigation system 734 and GPS system 736) as well as the operating performance of any of a variety of vehicle systems (e.g., battery pack charge level for an EV, fuel level for an ICE-based or hybrid vehicle, selected gear, current entertainment system settings such as volume level and selected track information, external light settings, current vehicle speed (e.g., via speed sensor 732), current HVAC settings such as cabin temperature and/or fan settings, etc.) via the thermal management system 726. Interface 405 may also be used to warn the driver of a vehicle condition (e.g., low battery charge level or low fuel level) and/or communicate an operating system malfunction (battery system not charging properly, low oil pressure for an ICE-based vehicle, low tire air pressure, etc.). Vehicle 700 can also include other features like an internal clock 716 and a calendar 714.

In some embodiments, user interface 704 includes one or more interfaces including, for example, a front dashboard display (e.g., a cockpit display, etc.), a touch-screen display (e.g., a pilot panel, etc.), as well as a combination of various other user interfaces such as push-button switches, capacitive controls, capacitive switches, slide or toggle switches, gauges, display screens, warning lights, audible warning signals, etc. It should be appreciated that if user interface 704 includes a graphical display, controller 701 may also include a graphical processing unit (GPU), with the GPU being either separate from or contained on the same chip set as the processor. User interface 704 may be referred to as a human machine interface (HMI).

Vehicle 700 also includes a drive train 706 that can include an internal combustion engine, one or more motors, or a combination of both. The vehicle's drive system can be mechanically coupled to the front axle/wheels, the rear axle/wheels, or both, and may utilize any of a variety of transmission types (e.g., single speed, multi-speed) and differential types (e.g., open, locked, limited slip). Drive train 706 may also comprise one or more drive units each comprising a drive circuit and respective motor.

Drivers often alter various vehicle settings, either when they first enter the car or while driving, in order to vary the car to match their physical characteristics, their driving style and/or their environmental preferences. System controller 701 monitors various vehicle functions that the driver may use to enhance the fit of the car to their own physical characteristics, such as seat position (e.g., seat position, seat height, seatback incline, lumbar support, seat cushion angle and seat cushion length) using seat controller 718 and steering wheel position using an auxiliary vehicle system controller 710. In some embodiments, system controller 701 also can monitor a driving mode selector 712 which is used to control performance characteristics of the vehicle (e.g., economy, sport, normal). In some embodiments, system controller 701 can also monitor suspension characteristics using auxiliary vehicle system 710, assuming that the suspension is user adjustable. In some embodiments, system controller 701 also monitors those aspects of the vehicle which are often varied by the user in order to match his or her environmental preferences for the cabin 726, for example setting the thermostat temperature or the recirculation controls of the thermal management system 726 that uses an HVAC controller, and/or setting the radio station/volume level of the audio system using controller 720, and/or setting the lights, either internal lighting or external lighting, using light controller 730. Also, besides using user-input and on-board sensors, system controller 701 can also use data received from an external on-line source that is coupled to the controller via communication link 708 (using, for example, GSM, EDGE, UMTS, CDMA, DECT, Wi-Fi, WiMax, etc.). For example, in some embodiments, system controller 701 can receive weather information using an on-line weather service 738 or an on-line data base 742, traffic data 740 for traffic conditions for the navigation system 734, charging station locations from a charging station database 744, etc. In some embodiments, communication link 708 comprises an Ethernet communication link with an Ethernet Port for external communications.

The system controller 701 can transfer information with the components described above over one or more internal networks, such as those, for example, described above. In some embodiments, the system controller 701 is communicably coupled to one or more of these components via an Ethernet communication network (e.g., an Ethernet Ring, etc.). The Ethernet communication network can be used to transfer other data such as data related to, but not limited to, one or more of a driver-assistance system, telematics, over-the-air updates, etc.

The vehicle may comprise a thermal management system 728 which may include one or more temperature sensors, one or more cooling systems (e.g., liquid lines, coolant, pump, fan, heatsink, heat pipe, cooler, evaporator, refrigeration, etc.).

The vehicle may comprise a telematics control unit (TCU) 746 that is responsible for software and firmware updates and for gathering signals to or from each of the components of the vehicle (e.g., GPS 429, navigation system 430, speed sensor 426, light controller 431, thermal management 421, energy storage system 440, seat controller 415, audio system 423, vehicle aux systems 417, vehicle mode selector 419, calendar 427, user interface 405, clock 425, vehicle management 401, communications link 409, or other components not shown. TCU 460 may be integral to vehicle management 401 or separate.

TCU 736 may communicate telemetry data with vehicle cyber security monitoring system 748. The vehicle cyber security monitoring system 748 may be a cloud-based application that is configured to receive data associated with a vehicle, the data comprising one or more logs associated with the vehicle and the telemetry data generated by the vehicle (e.g., TCU). The vehicle cyber security monitoring system 748 detects a data anomaly associated with the vehicle, based on applying at least a machine learning model to the data. In response to detecting the data anomaly to the vehicle, the vehicle cyber security monitoring system 748 performs a remediation action and stores the data anomaly (e.g., an indication thereof) in memory. Vehicle cyber security monitoring system 748 may be configured to train, select, and deploy machine learning models for vehicle anomaly detection, as described in other sections.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

The preceding description sets forth numerous specific details such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format in order to avoid unnecessarily obscuring the present disclosure. Thus, the specific details set forth are merely exemplary. Particular embodiments may vary from these exemplary details and still be contemplated to be within the scope of the present disclosure.

Reference throughout this specification to “one embodiment” or “an embodiment” means that a particular feature, structure, or characteristic described in connection with the embodiments included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Additionally, some embodiments may be practiced in distributed computing environments where the machine-readable medium is stored on and or executed by more than one computer system. In addition, the information transferred between computer systems may either be pulled or pushed across the communication medium connecting the computer systems.

Embodiments of the claimed subject matter include, but are not limited to, various operations described herein. These operations may be performed by hardware components, software, firmware, or a combination thereof.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not necessarily have an ordinal meaning according to their numerical designation.

What is claimed is:

1. A method comprising:
receiving data associated with a vehicle, the data comprising one or more logs associated with the vehicle and telemetry data generated by the vehicle;
detecting a data anomaly associated with the vehicle, including applying at least a machine learning model to the data;
in response to detecting the data anomaly to the vehicle, performing a remediation action; and
storing the data anomaly in memory.

2. The method of claim 1, further comprising:
training the machine learning model with unlabeled training data, including training the machine learning model to detect a reoccurring pattern between the one or more logs associated with the vehicle and the telemetry data generated by the vehicle.

3. The method of claim 2, wherein training the machine learning model comprises:
training a plurality of machine learning models with the unlabeled training data,
selecting a subset of the plurality of machine learning models based on a performance metric associated with each of the plurality of machine learning models, and
displaying the subset of machine learning models.

4. The method of claim 3, wherein training the machine learning model further comprises:
applying labeled test data to the subset of machine learning models; and
selecting the machine learning model from the subset of machine learning models based on a difference between output of each of the subset of machine learning models and the labeled test data.

5. The method of claim 4, wherein selecting the subset of the machine learning models comprises ranking the machine learning models based on the performance metric, wherein the performance metric is associated with a cluster quality of the unlabeled training data by each of the plurality of machine learning models.

6. The method of claim 1, wherein performing the remediation action comprises:
determining a current driving scenario associated with the vehicle;
determining a category of the data anomaly;
in response to the current driving scenario and the category of the data anomaly satisfying a condition, causing a notification through a first device that is external to the vehicle; and
in response to the current driving scenario and the category of the data anomaly satisfying a second condition, causing a second notification through a human machine interface that is internal to the vehicle.

7. The method of claim 6, wherein the condition comprises that the vehicle is stationary and the data anomaly is categorized as a security threat.

8. The method of claim 6, wherein the second condition comprises that the vehicle is moving and the data anomaly is categorized as affecting driving of the vehicle.

9. The method of claim 1, wherein detecting the data anomaly further comprises:
applying a condition-based rule to the data which detects a second data anomaly or detects the same data anomaly detected by the machine learning model.

10. The method of claim 9, further comprising:
storing an indication of each instance the condition-based rule detected a second data anomaly that the machine learning model does not detect, or storing an indication of each instance that the machine learning model detected the data anomaly that the condition-based rule does not detect, or storing a third indication of each instance that both the machine learning model and the condition-based rule detect the same data anomaly.

11. The method of claim 1, where in the one or more logs comprises at least one of an electronic control unit (ECU) log, and over-the-air (OTA) log, and application programming interface (API) log, a virtual private network (VPN) log, a mobile gateway log or other log.

12. The method of claim 1, wherein the telemetry data comprises a plurality of signals communicated over a bus of the vehicle, the plurality of signals comprising at least one of: a vehicle controller status, a vehicle operational status, a drive command, a network connectivity status, a sensed environmental condition, or a vehicle location.

13. A system comprising:
a memory; and
one or more processors coupled to the memory, the one or more processors configured to perform operations, comprising:
receiving data associated with a vehicle, the data comprising one or more logs associated with the vehicle and telemetry data generated by the vehicle;
detecting a data anomaly associated with the vehicle, including applying at least a machine learning model to the data;
in response to detecting the data anomaly to the vehicle, performing a remediation action; and
store the data anomaly in memory.

14. The system of claim 13, wherein the operations further comprise:
training the machine learning model with unlabeled training data, including training the machine learning model to detect a reoccurring pattern between the one or more logs associated with the vehicle and the telemetry data generated by the vehicle.

15. The system of claim 14, wherein training the machine learn model comprises:
training a plurality of machine learning models with the unlabeled training data,
selecting a subset of the plurality of machine learning models based on a performance metric associated with each of the plurality of machine learning models, and
displaying the subset of machine learning models.

16. The system of claim 15, wherein training the machine learn model further comprises:
applying labeled test data to the subset of machine learning models; and
selecting the machine learning model from the subset of machine learning models based on a difference between output of each of the subset of machine learning models and the labeled test data.

17. A non-transitory computer readable storage medium storing instructions, which when executed by a computing device, causes the computing device to perform operations comprising:
receiving data associated with a vehicle, the data comprising one or more logs associated with the vehicle and telemetry data generated by the vehicle;
detecting a data anomaly associated with the vehicle, including applying at least a machine learning model to the data;
in response to detecting the data anomaly to the vehicle, performing a remediation action; and
store the data anomaly in memory.

18. The non-transitory computer readable storage medium of claim 17, wherein the operations further comprise:
training the machine learning model with unlabeled training data, including training the machine learning model to detect a reoccurring pattern between the one or more logs associated with the vehicle and the telemetry data generated by the vehicle.

19. The non-transitory computer readable storage medium of claim 18, wherein training the machine learn model comprises:
training a plurality of machine learning models with the unlabeled training data,
selecting a subset of the plurality of machine learning models based on a performance metric associated with each of the plurality of machine learning models, and
displaying the subset of machine learning models.

20. The non-transitory computer readable storage medium of claim 19, wherein training the machine learn model further comprises:
applying labeled test data to the subset of machine learning models; and
selecting the machine learning model from the subset of machine learning models based on a difference between output of each of the subset of machine learning models and the labeled test data.
